(19) United States
(12) Patent Application Publication
(10) Pub. No.: US 2023/0256847 A1
(43) Pub. Date: Aug. 17, 2023

(54) CHARGING SYSTEM FOR AN ELECTRIC HOME ENERGY STORAGE AND METHOD FOR CHARGING A HOME ENERGY STORAGE

(71) Applicant: AUDI AG, Ingolstadt (DE)

(72) Inventor: Martin DEHM, Monheim (DE)

(21) Appl. No.: 18/169,099

(22) Filed: Feb. 14, 2023

(30) Foreign Application Priority Data
Feb. 15, 2022 (DE) 102022103470.4

(51) Int. Cl. B60L 53/50; B60L 53/16; H02J 7/14

(52) U.S. Cl. CPC B60L 53/50; B60L 53/16; H02J 7/1423; H02J 2310/12; H02J 2310/48; B60L 2210/30

(57) ABSTRACT

A charging system for an electrical home energy storage feeding a home alternating current supply network, which is connected across an AC-DC converter to the home alternating current supply network, comprises a coupling device for the direct charging of the home energy storage from at least one electrical motor vehicle energy accumulator of a motor vehicle, the motor vehicle having a bidirectional onboard charging device with at least one motor vehicle connection device, wherein the coupling device comprises: a coupling connection device designed for connection to the motor vehicle connection device, and a converter device for converting the electric power put out from the motor vehicle through the motor vehicle connection device into charging power for the home energy storage.

### BACKGROUND

### Technical Field

Embodiments of the invention relate to a charging system for an electrical home energy storage feeding a home alternating current supply network, especially an electrical home energy storage associated with a household, which is connected across an AC-DC converter to the home alternating current supply network. In addition, embodiments of the invention relate to a method for charging such a home energy storage.

### Description of the Related Art

Motor vehicles have had electric energy accumulators for a long time already. At first, motor vehicles driven by combustion engines were known, in which the motor vehicle electric energy accumulator supplied the electric onboard network of the motor vehicle as a low-voltage battery, such as a 12 V lead battery. Modern drive technologies in electrified motor vehicles led to the use of high-voltage batteries as the motor vehicle electric energy accumulator, which can also feed drive equipment, especially electric motors. In particular, it is possible to provide the motor vehicle with an onboard charging device (often called an onboard charger), so that the motor vehicle can be charged from an external electric energy source across a motor vehicle connection device, and thus a charging port. In particular, motor vehicle-external chargers, such as so-called wall boxes, were also proposed in this regard for private households, for example associated with houses or residences, by which the motor vehicle can be charged from a power supply grid, especially also a home alternating current supply network.

On the other hand, in the context of modern power applications, energy generators have also been proposed, especially for private households, like residences and/or houses. One prominent example of such energy generating devices for so-called “green current” or “green electricity” are photovoltaic layouts. These can feed current, for example that obtained through solar radiation, into the home alternating current supply network. Since the times during which this “green current” can be produced do not always coincide with the corresponding times of need, or even independently of this issue, electric home energy storages have furthermore been proposed which can serve as a buffer storage in the case of an electric energy generating device. For example, such a home energy storage can be charged during the day by solar radiation by means of a photovoltaic device and at night feed the generated electric energy into the home alternating current supply network. Such a home energy storage can have an electric energy capacity between 5 and 20 kWh, for example. Home alternating current supply networks usually work with a particular lower voltage than overhead lines or intermediate grids of public energy suppliers, for example with operating voltages <1000 V, especially with a rated voltage of 230 V at 50 Hz.

In the prior art there are also already proposals for incorporating motor vehicles into a modern and especially an environmentally friendly energy management. For example, it has been proposed for this to design the onboard charging devices of the motor vehicles and/or motor vehicle-external chargers for a bidirectional charging. This means that it is not only possible to charge a motor vehicle energy accumulator from a power supply grid, but also to feed this power supply grid from the motor vehicle energy accumulator. Various kinds of bidirectional charging approaches have become known for this, such as bidirectional AC systems and, in the more widespread case, DC charging systems.

However, the specific and also in particular the economical implementing of these approaches leads to problems in the prior art. Thus, in the case of bidirectional AC systems, grid-specific and especially country-individual parameters in the motor vehicle need to be considered. Further challenges exist for the safety of the connection to the home alternating current supply network. In the implementing of bidirectional DC systems, for example with bidirectional DC chargers, especially DC wall boxes, although grid-specific parameters are not relevant in the motor vehicle itself, since the direct current charging interface used obeys a standard, nevertheless in this case the motor vehicle-external charger must take on the duties of the connection to the home alternating current supply network. The result is an extremely large power electronics expense; on the other hand, there are increasingly many requirements in the case of direct current charging arrangements of the prior art in regard to intelligent, complex communication between the onboard charging device and the motor vehicle-external charger.

Although approaches have already been proposed in the prior art for realizing intelligent energy management approaches, for example controlled by a central control apparatus, and also allowing a use of electric energy stored in a motor vehicle energy accumulator for a household, nevertheless the power electronics components and control system intelligence demand a large investment expenditure, making this approach beyond the reach of many users of motor vehicles on account of the high costs.

DE 10 2016 202 798 A1 relates to an electric vehicle and a method for temporary utilization of the electric vehicle as a grid buffer for an electric power supply grid. The electric vehicle here has a main storage as well as a supplemental storage and a power electronics, which can be connected across a bidirectional interface to a bidirectional charging station of an electric power supply grid. The main storage and supplemental storage can be charged through the bidirectional charging station, controlled from the outside independently of each other, while the energy exchange with the electric power supply grid during its use as a grid buffer is controlled such that the supplemental storage is charged or discharged as a priority. In this way, the main storage will be protected against too many charging/discharging cycles.

### BRIEF SUMMARY

Some embodiments include a simple and low-cost possibility for utilization of energy stored in a motor vehicle energy accumulator in a home alternating current supply network.

Some embodiments include, in a charging system of the kind mentioned above, that the charging system for the direct charging of the home energy storage from at least one electrical motor vehicle energy accumulator of a motor vehicle, the motor vehicle having a bidirectional onboard charging device with at least one motor vehicle connection device, comprises a coupling device, which comprises:
a coupling connection device designed for connection to the motor vehicle connection device, and
a converter device for converting the electric power put out from the motor vehicle through the motor vehicle connection device into charging power for the home energy storage.

As with approaches already contemplated in the prior art, the bidirectionality given for the motor vehicle, therefore allowing both a charging of the motor vehicle energy accumulator and a discharging of the motor vehicle energy accumulator through the motor vehicle connection device, is exploited in order to use the energy stored in the motor vehicle energy accumulator also for a home alternating current supply network, which operates in a rated voltage range of less than 1000 V, especially less than 300 V, and which can be associated with a household, especially a house or a residence, however in some embodiments no direct feeding or utilization as a buffer energy storage is proposed, but instead it is proposed to use an already existing home energy storage, the capacity of which may lie for example in the range of 5 to 20 kWh, as an intermediate station or also a “man in the middle,” by which the energy can be fed into the home alternating current supply network. Such a charging arrangement comprising the motor vehicle and the charging system can be understood as being a home storage expansion, since ultimately the motor vehicle energy accumulator is connected to the home energy storage. The fact that the home energy storage through its DC-AC converter already has an optimal intelligent connection to the home alternating current supply network is exploited, so that this complex connection expense for the motor vehicle and its motor vehicle energy accumulator can be avoided. Instead, as will be explained more closely in specific embodiments, an extremely simple configuration results, in which the motor vehicle can be connected ultimately by a simple plug-in connection, formed from the motor vehicle connection device and a coupling connection device, and electric energy can be transferred from the motor vehicle energy accumulator of the motor vehicle into the home energy storage, from which it can be utilized for the home alternating current supply network, for example for a house, a residence, or the like. The only modification needed for this occurs in the coupling device, so that the embodiments described herein have special advantage as a retrofitted solutions, because ultimately only one converter device (with suitable terminal) needs to be added or slightly modified, if a converter device is already being used, as will be further discussed.

In some embodiments, no change in the house installation is therefore needed, since the wiring (by adding the coupling device) is changed only after the DC-AC converter. Moreover, neither is there any safety-critical intervention needed in the home alternating current supply network, since neither is this connection of the home energy storage to the power supply grid changed, and a safe connection already exists here. The communication complexity can be greatly reduced in the context of the embodiments described herein.

Since in particular no modification of any kind is needed as well on the part of the motor vehicles, the motor vehicles already present in the field can therefore be connected to a home energy storage. This retrofitting advantage also holds with regard to already installed home energy storage by virtue of the adding of a coupling device.

It should be noted already in this place that the motor vehicle energy accumulator can be a high-voltage energy accumulator and in particular a traction battery, which is designed to power a drive apparatus of the motor vehicle. For DC voltage, this means that a high-voltage energy accumulator has an operating voltage of at least 60 V. Inasmuch as traction accumulators, such as known traction batteries, are supposed to contribute to the propulsion in motor vehicles, they are often designed with a large storage capacity, which can be utilized to supply electricity to a household, for example in event of a power outage or at times of extremely high electricity rates. However, in the embodiments described herein, it is equally conceivable, alternatively or additionally, to also use a low-voltage energy accumulator, especially an onboard network battery. Hence it is conceivable, by providing a corresponding motor vehicle connection device for the low-voltage energy accumulator, to realize a charging of the home energy storage also through a traditional 12 V or 48 V onboard network battery. Even such “small” low-voltage energy accumulators, for example onboard network batteries like 12 V lead batteries, have a sufficient storage capacity to allow or sustain an operation of consumers in the home alternating current supply network, at least for a short time. In this regard, therefore, the motor vehicle need not be an electric motor vehicle or a hybrid motor vehicle, but also motor vehicles having only a combustion engine or the like can be used similarly in the context of the embodiments described herein.

In some embodiments, it can be provided that the charging system is configured for unidirectional charging of the home energy storage from the motor vehicle energy accumulator. This means that the connection produced by the coupling device between the motor vehicle energy accumulator and the home energy storage is merely adapted to charge the home energy storage from the motor vehicle energy accumulator, but not to charge the motor vehicle energy accumulator from the home energy storage, for which optionally motor vehicle-external chargers, such as wall boxes, can be used, as is known from the prior art, which can then be specially designed for a charging operation for the motor vehicle energy accumulator from the home alternating current supply network (or some other network). In this way, a cost-saving, less elaborate and complex design is possible, on the one hand with regard to the coupling device, where it can be provided for example that the converter device is designed for a charging power of 2 to 5 kW. Furthermore, it is also possible to reduce the power electronics for the household supply from the home energy storage, and therefore in particular the AC-DC converter, to a “discharging,” so that here as well instead of the otherwise necessary 11 kW a design for 2 to 5 kW is adequate. Finally, motor vehicle-external chargers can also remain basically unaffected.

It should be further noted in this place that an already proposed so-called “vehicle-to-device” connection can also be used as the motor vehicle connection device. For example, such connections have already been proposed as alternating current connections, in order to operate individual consumers by means of the motor vehicle. It is then possible, in a highly safe manner, to operate even entire home alternating current supply networks in particular with multiple connected consumers from the motor vehicle with the use of the “man-in-the-middle” home energy storage.

In this context, some embodiments provide that in the case of an alternating current, especially according to a standard for the motor vehicle providing the motor vehicle connection device:
the converter device comprises an AC-DC converter, which converts the provided alternating current free of communication into the charging current furnishing the charging power, and/or
the motor vehicle connection device and the coupling connection device form a Schuko or CEE plug-in connection.

For motor vehicles which provide an alternating voltage connection, thus in particular a “vehicle-to-device” connection, there exist basically two standards, namely, normal alternating voltages/alternating voltage powers which are also provided in households usually by the home alternating current supply network or also multiphase connections, such as are known for example for camping applications. For example, in Germany, the grid voltage at household connections is regulated by the DIN EN 60038 standard, and the grid voltage is 230 V (rated voltage)+/−23 V. In camping applications, alternating voltages with a rated voltage of 400 V are also customary. Classical plug-in connections for such standardized AC power provision are Schuko plug-in connections and CEE plug-in connections, which can also be used in the embodiments described herein and which are also usually provided anyway in the so-called “vehicle-to-device” connections for motor vehicles. The small number of common designs of such alternating current motor vehicle connection devices also allows an especially simple and safe design of the converter device, since basically only two voltage levels need to be considered, which significantly simplifies the connection to the home energy storage.

Some embodiments can also be used when a direct current is provided at the motor vehicle connection device. In this case, a DC voltage converter (DC-DC converter) is used as part of the converter device of the coupling device. Especially when the motor vehicle or its onboard charging device is designed anyway to negotiate network connection parameters, charging conditions and the like, one embodiment can provide in this regard that the charging system moreover comprises a communication device for negotiating the connection and/or charging conditions with the onboard charging device. In particular, an intelligent communication can be realized which is able not only to take account of states of charge and the like, but also allows in particular the connecting of different motor vehicle types with different electrical parameters in regard to the motor vehicle energy accumulator.

In one embodiment, it can be provided that the charging system moreover comprises an electrical energy generating device, especially a photovoltaic device, to which the home energy storage is coupled by means of a connection device for the charging from the energy generating device. In particular, the energy generating device generates so-called “green current,” i.e., it uses regenerative energy, such as solar power, since corresponding photovoltaic devices are already known for houses and buildings in the prior art. In this context, home energy storage, as described, is already provided in many households.

Advisedly, the connection device can comprise a DC voltage converter, which also forms or is part of the converter device of the coupling device. Some embodiments utilize converters which are present any way and associated directly or indirectly with the home energy storage also in the context of the coupling device so as to further save on components, complexity, and expense. In this context, the converter device can advisedly be associated with a switch device for switching the energy flow from the motor vehicle energy accumulator or from the energy generating device. For example, a so-called “power hub” can be used as the switching device, in order to determine the source from which the home energy storage is charged or even to adjust the makeup of the power. In this way, an optimal assortment of the different energy sources which can be used by the home energy storage and especially also buffer it is possible.

Besides the charging system, some embodiments include a method for charging an electrical home energy storage feeding a home alternating current supply network, especially an electrical home energy storage associated with a household, which is connected across an AC-DC converter to the home alternating current supply network, especially by means of a charging system as described herein. In some embodiments, the method involves charging the home energy storage directly from at least one electric motor vehicle energy accumulator of a motor vehicle, the motor vehicle having a bidirectional onboard charging device with a motor vehicle connection device, wherein:
the home energy storage is connected to the motor vehicle by means of a coupling device having a converter device for converting the electric power put out by the motor vehicle across the motor vehicle connection device into charging power for the home energy storage and
it is charged from the motor vehicle energy accumulator.

All of the configurations regarding the charging system described herein can be transferred analogously to the method described herein, and hence the already mentioned benefits can be achieved with this. In particular, directly means here that the charging process occurs immediately through the electrical connection produced by the coupling device, but not through the home alternating current supply network.

As already explained, it also holds for the method described herein that the motor vehicle energy accumulator which is used is a high-voltage energy accumulator, especially a traction accumulator, which is designed to power a drive device of the motor vehicle, and/or a low-voltage energy accumulator, especially an onboard network battery.

It should be further noted in this place that various configurations are conceivable for the home energy storage. For example, the home energy storage can be a battery, especially a lead storage battery or a lithium ion storage battery.

### BRIEF DESCRIPTION OF THE SEVERAL VIEWS OF THE DRAWINGS

Further benefits and details will emerge from the embodiments described below, as well as the drawings.

FIG. 1 shows a functional representation of a first embodiment.

FIG. 2 shows a functional representation of a second embodiment.

FIG. 3 shows a functional representation of a third embodiment.

FIG. 4 shows a functional representation of a fourth embodiment.

### DETAILED DESCRIPTION

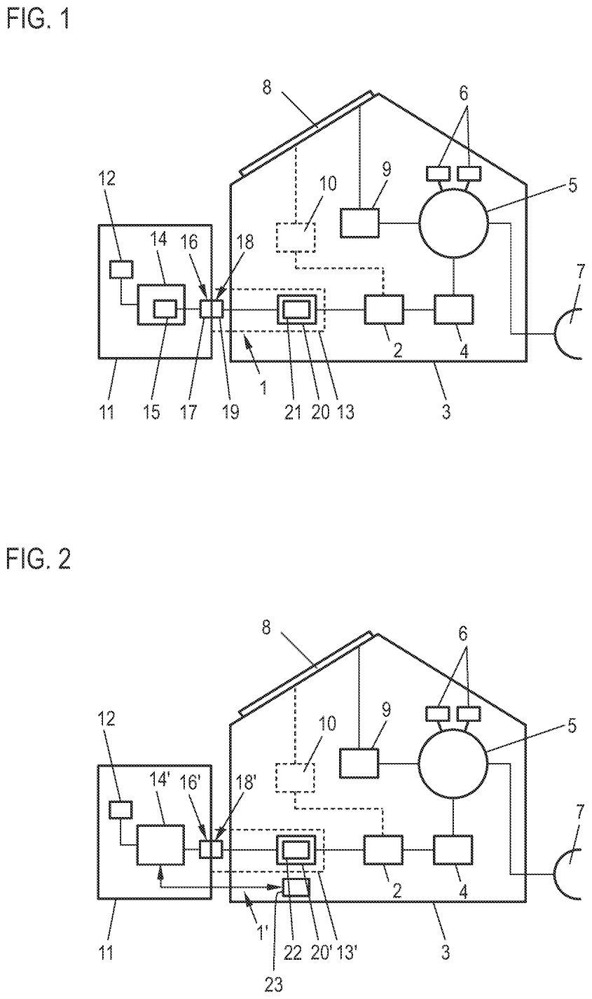

FIG. 1 shows a functional representation of a first embodiment of a charging system 1 for a home energy storage 2, such as at least one lithium ion battery. The home energy storage 2 is associated with a household, in the present instance a house 3, and connected across an AC-DC converter 4 to a home alternating current supply network 5, by which for example various consumers 6 in the house 3 can also be powered. The home alternating current supply network 5 can be connected in basically known manner to a public electrical power supply grid 7, only suggested here.

In the present case, solar cells of a photovoltaic device 8 are furthermore provided on the roof of the house 3, and the electric power generated here can be stored across a further AC-DC converter 9 in the home alternating current supply network 5, from which it can be used to charge the home energy storage 2. However, in an alternative embodiment, shown here in dashed lines, it is also possible to connect a DC voltage converter 10 in addition or alternatively to the photovoltaic device 8 and use this for the direct charging of the home energy storage 2.

In order to also charge the home energy storage 2 from a motor vehicle 11, or more precisely from a motor vehicle energy accumulator 12, in the present case the charging system 1 is provided, having the coupling device 13.

The motor vehicle 11 can be for example an electric motor vehicle. In this case, the motor vehicle energy accumulator 12 can be a high-voltage battery, from which a drive apparatus of the motor vehicle 11, such as an electric motor, not further shown here, can also be operated. The motor vehicle 11 also comprises an onboard charging device 14, by which the motor vehicle energy accumulator 12 can be charged in a manner not otherwise represented here for sake of clarity, for example directly from the home alternating current supply network 5 or another network, for which an appropriate charger can be used, such as a wall box. Inasmuch as an external connection of the motor vehicle 11 should occur in the present case by means of alternating current, the onboard charging device 14 comprises an inverter 15, which is connected to a motor vehicle connection device 16, here a conventional Schuko plug 17. The onboard charging device 14 is designed for so-called bidirectional charging, and therefore it can receive both alternating current power via the motor vehicle connection device 16 (or another connection) in order to charge the motor vehicle energy accumulator 12, and also provide alternating current power via the motor vehicle connection device 16 in order to discharge the motor vehicle energy accumulator 12 accordingly. Some embodiments provide multiple motor vehicle connection devices 16 serving different purposes, for example one motor vehicle connection device provided especially for the charging and one motor vehicle connection device 16 especially for the discharging.

In order to allow a direct charging of the home energy storage 2, and thus without involvement of the home alternating current supply network 5, the coupling device 13 in the present instance comprises on the one hand a coupling connection device 18, in the present instance a conventional Schuko plug 19, so that a Schuko connection can be formed. Alternatively, it is also conceivable, especially for another voltage level, to use a CEE plug-in connection.

Moreover, the coupling device 13 comprises a converter device 20, which in the present instance comprises a further inverter 21 (AC-DC converter) in order to transform the alternating current power provided by the motor vehicle 11 into a charging power for the home energy storage 2. In other words, the AC-DC converter 21 converts the provided alternating current into the charging current providing the charging power, no communication of any kind between the motor vehicle and the charging system being required for this.

The converter device 20 here is especially designed for two voltage levels, namely, one voltage level of a rated voltage of 230 V and one voltage level of a rated voltage of 400 V, as is often customary, because the motor vehicle connection device 16 in the present instance is a so-called “vehicle-to-device” connection, from which individual devices can also be operated.

It should be further noted that, in addition or alternatively to a high-voltage battery, one can also use a low-voltage battery, such as a 12 V onboard network battery, in this manner in order to charge the home energy storage 2.

Through the charging arrangement formed by the motor vehicle 11 and the charging system 1, as regards the feeding of electric energy from the motor vehicle to the home alternating current supply network 5, the home energy storage 2 serves as a kind of “man in the middle,” which not only significantly simplifies the design and the connection and allows a more economical layout, but also provides safety, since the home energy storage 2 is already safety connected to the home alternating current supply network 5. A safe connection to the motor vehicle 11 can be produced by the charging system 1, so that technical safety can be achieved in a simple manner, especially one allowing a retrofitting. Since in the present case the charging system 1 is used only for charging the home energy storage 2, i.e., unidirectionally, the converter device 20 and the AC-DC converter 4 for the power supply grid 5 can be smaller in design, for example, for a power of 2 to 5 kW.

FIG. 2 shows a second embodiment of a charging system 1′, in which the onboard charging device 14′ furnishes the electric power as direct current via the motor vehicle connection device 16′, unlike the case of the embodiment of FIG. 1. Accordingly, the coupling device 13′ modified in this respect comprises in addition to the correspondingly adapted coupling connection device 18′ also a converter device 20′ having a DC voltage converter 22, in order to carry out the conversion to the charging power for the home energy storage 2. Moreover, the charging system 1′ has a communication device 23, by which coupling and/or charging conditions can be negotiated with the onboard charging device 14′.

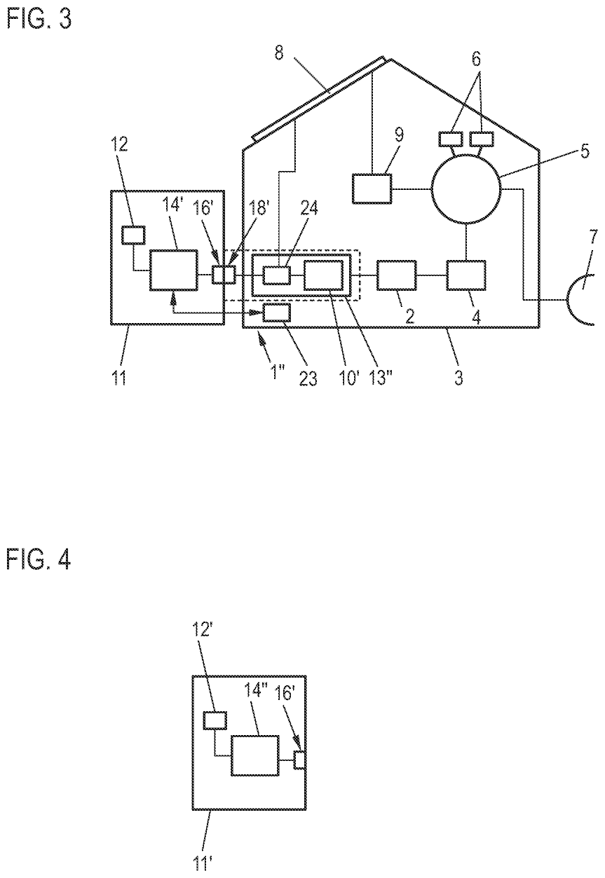

The third embodiment of FIG. 3 corresponds basically to that of FIG. 2, except that the DC voltage converter 10′ associated with the photovoltaic device 8 is also used in the converter device 20″ of the appropriately modified coupling device 13″ of the charging system 1″. In order to allow this, a switch device 24 is provided, such as a power hub, by which it can be selected whether to supply the photovoltaic power of the photovoltaic device 8 or the electric power of the motor vehicle 11 (or even a mixture of the two) to the home energy storage 2 for the charging.

FIG. 4 shows as an illustration of a fourth embodiment, which can be combined with the preceding embodiments, only the motor vehicle 11′, which in this case need not be an electric motor vehicle. Namely, in this case the motor vehicle energy accumulator 12′ is used, designed as a low-voltage accumulator, especially a 12 V onboard network battery, from which electric power is provided by means of the onboard charging device 14″.

German patent application no. 10 2022 103470.4, filed Feb. 15, 2022, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging system for an electrical home energy storage feeding a home alternating current supply network, which is connected across an AC-DC converter to the home alternating current supply network, comprising:
a coupling device for direct charging of the home energy storage from at least one electrical motor vehicle energy accumulator of a motor vehicle, the motor vehicle having a bidirectional onboard charging device with at least one motor vehicle connection device, wherein the coupling device comprises:
a coupling connection device designed for connection to the motor vehicle connection device, and
a converter device for converting the electric power put out from the motor vehicle through the motor vehicle connection device into charging power for the home energy storage.

2. The charging system according to claim 1, wherein the charging system is configured for unidirectional charging of the home energy storage from the motor vehicle energy accumulator.

3. The charging system according to claim 1, wherein:
in the case of an alternating current according to a standard for the motor vehicle providing the motor vehicle connection device:
the converter device comprises an AC-DC converter, which converts the provided alternating current free of communication to the charging current furnishing the charging power, and/or
the motor vehicle connection device and the coupling connection device form a Schuko or CEE plug-in connection.

4. The charging system according to claim 1, wherein in the case of a direct current at the motor vehicle providing the motor vehicle connection device, the charging system moreover comprises a communication device for negotiating the coupling and/or charging conditions with the onboard charging device.

5. The charging system according to claim 1, wherein the charging system moreover comprises an electrical energy generating device to which the home energy storage is coupled by a connection device for the charging from the energy generating device.

6. The charging system according to claim 5 wherein the electrical energy generating device is a photovoltaic device.

7. The charging system according to claim 5, wherein the connection device comprises a DC voltage converter, which also forms the converter device of the coupling device or a part of it.

8. The charging system according to claim 7, wherein the converter device is associated with a switch device for switching the energy flow from the motor vehicle energy accumulator or from the energy generating device.

9. The charging system according to claim 1, wherein the converter device is designed for a charging power of 2 to 5 kW.

10. A method for charging an electrical home energy storage feeding a home alternating current supply network, which is connected across an AC-DC converter to the home alternating current supply network, using a charging system, comprising:
charging the home energy storage directly from at least one electric motor vehicle energy accumulator of a motor vehicle, the motor vehicle having a bidirectional onboard charging device with a motor vehicle connection device, wherein:
the home energy storage is connected to the motor vehicle by a coupling device having a converter device for converting the electric power put out by the motor vehicle across the motor vehicle connection device into charging power for the home energy storage; and
it is charged from the motor vehicle energy accumulator.

11. The method according to claim 10, wherein the motor vehicle energy accumulator which is used is a high-voltage energy accumulator, which is designed to power a drive device of the motor vehicle, and/or a low-voltage energy accumulator.

12. The method according to claim 11 wherein the high-voltage energy accumulator is a traction accumulator.

13. The method according to claim 11 wherein the low-voltage energy accumulator is an onboard network battery.
